(19) United States
(12) Patent Application Publication
(10) Pub. No.: US 2025/0251686 A1
(43) Pub. Date: Aug. 7, 2025

(54) IMAGE FORMING APPARATUS

(71) Applicant: KYOCERA Document Solutions Inc., Osaka (JP)

(72) Inventors: Atsuki Ito, Osaka (JP); Makoto Matsumoto, Osaka (JP); Ayato Morikami, Osaka (JP); Yasuaki Sakamoto, Osaka (JP); Masaru Watanabe, Osaka (JP); Yukiko Kotani, Osaka (JP)

(21) Appl. No.: 19/047,554

(22) Filed: Feb. 6, 2025

(30) Foreign Application Priority Data
Feb. 7, 2024 (JP) 2024-016881

(51) Int. Cl. G03G 15/00; G03G 15/01

(52) U.S. Cl. CPC G03G 15/5058; G03G 15/0189; G03G 2215/00059

(57) ABSTRACT

A control portion causes an image forming portion to execute a test output process in which a plurality of test toner images each having a different developing voltage condition are formed in sequence on a surface of each of a plurality of image-carrying members and then transferred to an intermediate transfer body. The control portion sequentially selects, from the plurality of image-carrying members, target image-carrying members that are arranged at a distance greater than an arrangement spacing of the plurality of image-carrying members, and causes the image forming portion to execute the test output process so that each time one of the plurality of target image-carrying members is selected, the plurality of test toner images for each of the plurality of target image-carrying members are transferred within an area on the surface of the intermediate transfer body whose length corresponds to pacing between the plurality of target image-carrying members.

### INCORPORATION BY REFERENCE

This application is based upon and claims the benefit of priority from the corresponding Japanese Patent Application No. 2024-016881 filed on Feb. 7, 2024, the entire contents of which are incorporated herein by reference.

### BACKGROUND

The present disclosure relates to an image forming apparatus that forms a plurality of test toner images on a surface of an intermediate transfer body and adjusts an image forming portion in accordance with densities of the plurality of test toner images.

In an electrophotographic image forming apparatus, various types of conditions such as a charge amount of toner affect density of an output image.

It is known that an image forming apparatus forms a plurality of types of gradation patterns on a surface of a transfer belt and detects densities of the plurality of types of gradation patterns using an optical sensor. The image forming apparatus performs image density control in accordance with the detected densities of the plurality of types of gradation patterns.

### SUMMARY

An image forming apparatus according to one aspect of the present disclosure includes an image forming portion, a transfer device, a density detecting portion, and a control portion. The image forming portion includes a plurality of image-carrying members arranged with spacing in between and a plurality of toner-carrying members arranged corresponding to the plurality of image-carrying members and to which a common developing voltage is applied, and is configured to form a toner image of each of a plurality of development colors on a surface of each of the plurality of image-carrying members by toner supplied from each of the plurality of toner-carrying members. The transfer device includes an intermediate transfer body that transfers the toner images on the surfaces of the plurality of image-carrying members to the intermediate transfer body, and is configured to further transfer the toner images transferred to the intermediate transfer body to a sheet. The density detecting portion detects density of the toner images formed on a surface of the intermediate transfer body. The control portion is configured to cause the image forming portion to execute a test output process in which a plurality of test toner images, each having a different developing voltage condition, are sequentially formed on the surface of each of the plurality of image-carrying members and transferred to the intermediate transfer body, and adjust the image forming portion in accordance with the densities of the plurality of test toner images detected by the density detecting portion. The control portion sequentially selects from the plurality of image-carrying members a plurality of target image-carrying members that are arranged at a distance greater than an arrangement spacing of the plurality of image-carrying members, and causes the image forming portion to execute the test output process so that each time one of the plurality of target image-carrying members is selected, the plurality of test toner images for each of the plurality of target image-carrying members are transferred within an area on the surface of the intermediate transfer body whose length corresponds to the spacing between the plurality of target image-carrying members.

An image forming apparatus according to another aspect of the present disclosure includes the image forming portion, the transfer device, the density detecting portion, and a control portion. The control portion is configured to cause the image forming portion to execute a test output process in which a plurality of test toner images, each having a different developing voltage condition, are sequentially formed on the surface of each of the plurality of image-carrying members and transferred to the intermediate transfer body, and adjust the image forming portion in accordance with the densities of the plurality of test toner images detected by the density detecting portion. The control portion causes the image forming portion to execute the test output process so that the plurality of test toner images for each of the plurality of image-carrying members are transferred within an area having a length corresponding to the arrangement spacing of the plurality of image-carrying members on the surface of the intermediate transfer body.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a configuration diagram of a developing device in an image forming apparatus according to an embodiment.

FIG. 3 is a block diagram showing a configuration of a control device in an image forming apparatus according to an embodiment.

FIG. 4 is a flowchart showing a first example of a procedure of test output control in an image forming apparatus according to an embodiment.

FIG. 5 is a flowchart showing an example of a procedure for a development parameter adjustment process in an image forming apparatus according to an embodiment.

FIG. 6 is a diagram showing a state in which a first test output is performed for a first target photoconductor in a first example of a procedure of test output control in an image forming apparatus according to an embodiment.

FIG. 7 is a diagram showing a state in which a second test output is performed for a first target photoconductor in a first example of a procedure of test output control in an image forming apparatus according to an embodiment.

FIG. 8 is a diagram showing a state in which a third test output is performed for a first target photoconductor in a first example of a procedure of test output control in an image forming apparatus according to an embodiment.

FIG. 9 is a diagram showing a state in which a first test output is performed for a second target photoconductor in a first example of a procedure of test output control in an image forming apparatus according to an embodiment.

FIG. 10 is a diagram showing a state in which a third test output is performed for a second target photoconductor in a first example of a procedure of test output control in an image forming apparatus according to an embodiment.

FIG. 11 is a flowchart showing a second example of a procedure of test output control in an image forming apparatus according to an embodiment.

FIG. 12 is a diagram showing a state in which a first test output is performed in a second example of a procedure of test output control in an image forming apparatus according to an embodiment.

FIG. 13 is a diagram showing a state in which a third test output is performed in a second example of a procedure of test output control in an image forming apparatus according to an embodiment.

### DETAILED DESCRIPTION

Hereinafter, embodiments according to the present disclosure will be described with reference to the drawings. Note that the following embodiments are examples according to the present disclosure and do not limit the technical scope of the present disclosure.

### [Configuration of Image Forming Apparatus 10]

An image forming apparatus 10 according to an embodiment is capable of performing a printing process by electrophotography. The printing process is a process for forming an image on a sheet 9. The sheet 9 is an image forming medium such as paper or a resin sheet.

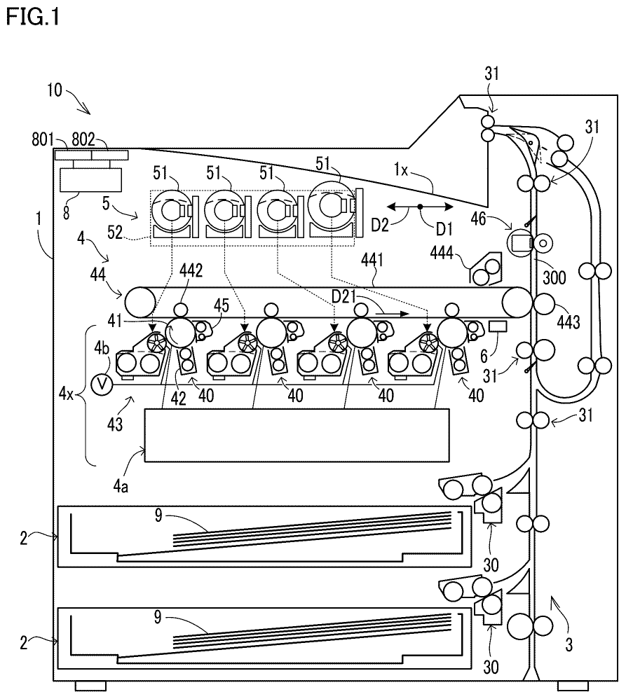

The image forming apparatus 10 shown in FIG. 1 is a printer. Note that the image forming apparatus 10 may be a copying machine, a facsimile apparatus, a multifunction peripheral, or the like.

As shown in FIG. 1, the image forming apparatus 10 includes a main housing 1, a sheet storing portion 2, a conveying device 3, a printing device 4, a toner supply device 5, a control device 8, an operation device 801, and a display device 802.

The main housing 1 is a housing that houses the conveying device 3, the printing device 4, the toner supply device 5, and the control device 8. A conveying path 300 that is a path for the sheet 9 is provided within the main housing 1.

The conveying device 3 includes a sheet feeding mechanism 30 and a plurality of sets of conveying roller pairs 31. The sheet feeding mechanism 30 feeds the sheets 9 housed in the sheet storing portion 2 one by one to the conveying path 300.

The plurality of sets of conveying roller pairs 31 convey the sheet 9 along the conveying path 300. One set of the plurality of conveying roller pairs 31 discharges the sheet 9, on which an image has been formed by the printing device 4, from the conveying path 300 onto a discharge tray 1x.

The printing device 4 executes the printing process on the sheet 9 conveyed along the conveying path 300. In the example shown in FIG. 1, the printing device 4 executes the printing process by electrophotography. The printing device 4 is a tandem type color printing device.

The printing device 4 includes an image forming portion 4x, a transfer device 44, and a fixing device 46. The image forming portion 4x includes an exposure device 4a, a plurality of unit image forming portions 40 corresponding to a plurality of development colors, and a voltage output circuit 4b.

In the present embodiment, the image forming portion 4x includes four unit image forming portions 40 corresponding to the development colors of yellow, magenta, cyan and black.

Each of the unit image forming portions 40 includes a photoconductor 41, a charging device 42, a developing device 43, and a drum cleaning device 45. That is, the image forming portion 4x includes four photoconductors 41, four charging devices 42, four developing devices 43, and four drum cleaning devices 45.

The four photoconductors 41 are arranged with spacing in between along a part of an intermediate transfer belt 441. In the present embodiment, the four photoconductors 41 are arranged with equal spacing in between.

The four photoconductors 41 rotate, and the four charging devices 42 charge the surfaces of the four photoconductors 41. The exposure device 4a scans the charged surface of each photoconductor 41 with a laser beam, thereby forming an electrostatic latent image on the surface of each photoconductor 41.

The developing device 43 supplies toner to the surface of the photoconductor 41 to develop the electrostatic latent image into a toner image.

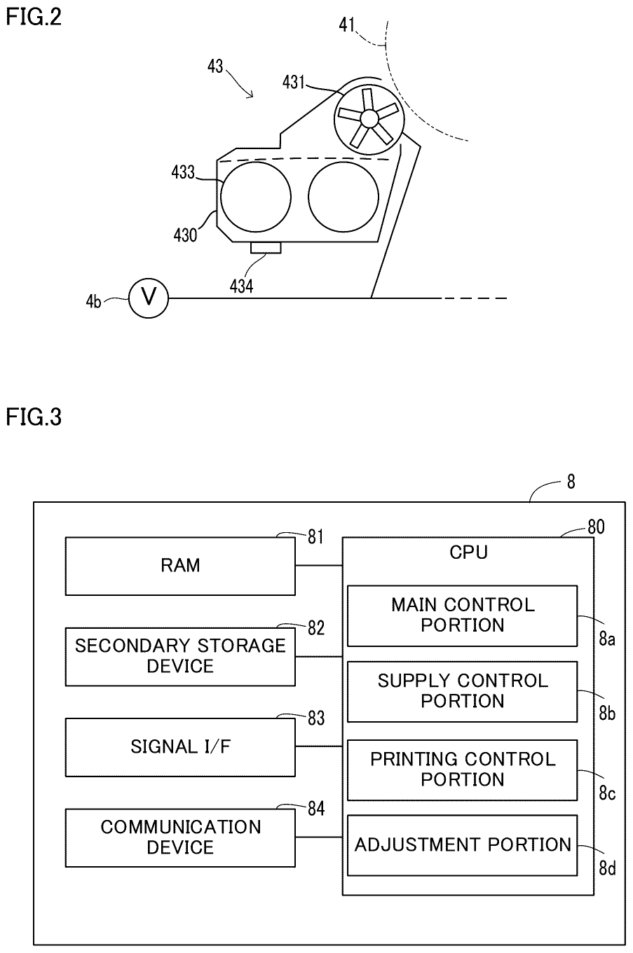

As shown in FIG. 2, each of the developing devices 43 includes a developing agent storage portion 430 and a developing roller 431. That is, the image forming portion 4x includes four developing agent storage portions 430 and four developing rollers 431 corresponding to the four development colors.

The four developing agent storage portions 430 and the four developing rollers 431 are arranged corresponding to the four photoconductors 41. Each of the developing agent storage portions 430 stores a two-component developing agent. The two-component developing agent includes a magnetic carrier and the toner supplied from the toner supply device 5.

The voltage output circuit 4b outputs a common developing voltage to the four developing rollers 431. The developing voltage is a bias voltage applied to each developing roller 431 with a potential of each photoconductor 41 as a reference.

The four developing rollers 431 are an example of a plurality of toner-carrying members to which the common developing voltage is applied. Each of the developing rollers 431 carries the toner in each of the developing agent storage portions 430.

Each of the developing rollers 431 supplies the toner to the surface of each of the photoconductors 41 to develop the electrostatic latent image into the toner image.

That is, the image forming portion 4x forms the toner images of the plurality of development colors on the surfaces of the four photoconductors 41 by the toner supplied from each of the four developing rollers 431. The four photoconductors 41 are an example of a plurality of image-carrying members each carrying a toner image.

Furthermore, each of the developing devices 43 includes a developing agent conveying member 433 and a remaining amount detection portion 434. The developing agent conveying member 433 rotates within the developing agent storage portion 430. The developing agent conveying member 433 conveys the two-component developing agent within the developing agent storage portion 430 while stirring the developing agent.

The remaining amount detection portion 434 detects the remaining amount of toner in the developing agent storage portion 430. In the present embodiment, the remaining amount detection portion 434 is a magnetic permeability sensor that detects the magnetic permeability inside the developing agent storage portion 430. A high magnetic permeability in the developing agent storage portion 430 indicates that the remaining amount of the toner in the developing agent storage portion 430 is small.

The transfer device 44 transfers the toner image on the surface of the photoconductor 41 onto the sheet 9 conveyed along the conveying path 300.

The transfer device 44 includes an intermediate transfer belt 441, four primary transfer devices 442, a secondary transfer device 443, and a belt cleaning device 444. The four primary transfer devices 442 are provided corresponding to the four photoconductors 41.

The intermediate transfer belt 441 rotates with a portion thereof being aligned with the four photoconductors 41. The longitudinal direction of each photoconductor 41 is a main scanning direction D1, and a direction perpendicular to the main scanning direction D1 is a sub-scanning direction D2 (see FIG. 1).

The four photoconductors 41 are arranged along the sub-scanning direction D2. A belt movement direction D21, which is the movement direction of the portion of the intermediate transfer belt 441 along the four photoconductors 41, is a direction from one side to the other side in the sub-scanning direction D2 (see FIG. 1).

The four primary transfer devices 442 transfer the toner images on the surfaces of the four photoconductors 41 onto the surface of the intermediate transfer belt 441. Thus, a color toner image, which is a composite of the toner images of a plurality of colors, is formed on the surface of the intermediate transfer belt 441.

The secondary transfer device 443 transfers the color toner image on the surface of the intermediate transfer belt 441 onto the sheet 9. That is, the transfer device 44 transfers the toner images on the surfaces of the four photoconductors 41 onto the surface of the intermediate transfer belt 441, and further transfers the toner images transferred onto the surface of the intermediate transfer belt 441 onto the sheet 9. The intermediate transfer belt 441 is an example of an intermediate transfer body.

The fixing device 46 applies heat and pressure to the toner image on the sheet 9 to fix the toner image to the sheet 9.

The toner supply device 5 supplies the four color toners to the four developing agent storage portions 430, respectively. The toner supply device 5 includes four toner containers 51 and a toner feeding mechanism 52.

The four toner containers 51 each contain a toner of a different development color. The toner feeding mechanism 52 feeds the toner contained in each of the toner containers 51 to the four developing agent storage portions 430. Each toner container 51 is removably mounted in the main housing 1.

The operation device 801 is a device that receives operations by a person. For example, the operation device 801 includes one or both of a touch panel and operation buttons.

The display device 802 is capable of displaying various types of information. For example, the display device 802 is a panel display device such as a liquid crystal display device. The control device 8 controls various types of electric devices included in the image forming apparatus 10.

As shown in FIG. 3, the control device 8 includes a central processing unit (CPU) 80, a random access memory (RAM) 81, a secondary storage device 82, a signal interface 83, a communication device 84, and the like.

The CPU 80 is an example of a processor that executes various types of controls and data processing by executing computer programs. The RAM 81 temporarily stores the computer programs executed by the CPU 80 and various types of data.

The secondary storage device 82 is a computer-readable non-volatile storage device. The secondary storage device 82 stores the computer programs executed by the CPU 80 and various types of data. For example, one or both of a flash memory or a hard disk drive may be employed as the secondary storage device 82.

The signal interface 83 converts detection signals from various types of sensors into digital detection data. The detection data is transmitted to the CPU 80.

The communications device 84 executes communication with a plurality of external devices, including one or more host devices, over a network. The CPU 80 executes communication with each of the external devices via the communication device 84. The host device is an information processing device that requests the image forming apparatus 10 to perform the printing process.

The CPU 80 includes a plurality of processing modules that are achieved by executing the computer programs. The plurality of processing modules include a main control portion 8a, a supply control portion 8b, and a printing control portion 8c (see FIG. 2).

The main control portion 8a executes a process of receiving various types of requests and executes control for causing other modules to execute processes according to the requests. For example, the main control portion 8a receives a print request via the operation device 801 or the communication device 84. Furthermore, the main control portion 8a causes the printing control portion 8c to execute processing in response to the print request.

The supply control portion 8b controls the toner supply device 5 to thereby control the supply of toner from the toner supply device 5 to the printing device 4.

In the present embodiment, the supply control portion 8b controls the amount of toner supplied by the toner supply device 5 to the developing device 43 in accordance with the difference between the remaining amount detected by the remaining amount detection portion 434 and a preset target remaining amount.

The printing control portion 8c controls the conveying device 3 and the printing device 4. The printing control portion 8c causes the conveying device 3 to convey the sheet 9, while causing the printing device 4 to execute the printing process.

The image forming portion 4x of the image forming apparatus 10 includes the plurality of photoconductors 41 and the plurality of developing rollers 431 to which the common developing voltage is applied. As described above, the image forming portion 4x forms the toner images of the plurality of development colors on the surfaces of the plurality of photoconductors 41 with the toner supplied from each of the plurality of developing rollers 431.

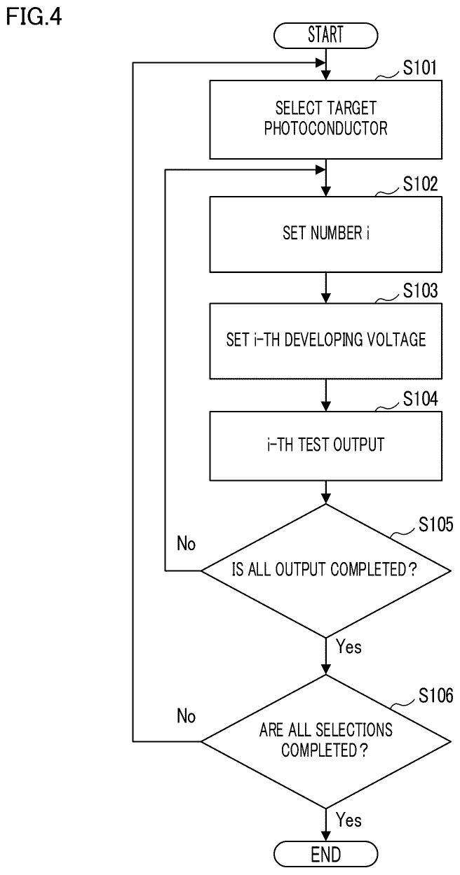

The image forming apparatus 10 executes test output control, which will be described later (see FIGS. 4 and 11). In the test output control, the image forming apparatus 10 sequentially forms a plurality of test toner images, each of which has a different developing voltage condition, on the surface of each of the plurality of photoconductors 41, and transfers the plurality of test toner images onto the surface of the intermediate transfer belt 441.

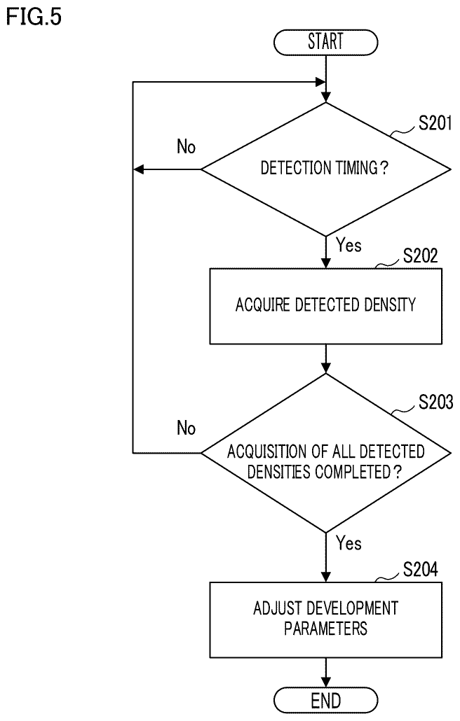

Furthermore, the image forming apparatus 10 executes a development parameter adjustment process (to be described later) in parallel with the test output control (see FIG. 5). The image forming apparatus 10 further includes a density detecting portion 6 used in the development parameter adjustment process (see FIG. 1). The density detecting portion 6 detects the density of the toner image formed on the surface of the intermediate transfer belt 441.

For example, the density detecting portion 6 is a reflective photosensor. In this case, the density detecting portion 6 irradiates the surface of the intermediate transfer belt 441 with light and detects an amount of diffuse reflection light reflected by the surface of the intermediate transfer belt 441.

The image forming apparatus 10 can detect the densities of the plurality of test toner images by the density detection unit 6 and adjust the image forming portion 4x in accordance with the detected densities.

Changing the developing voltage by the voltage output circuit 4b requires a predetermined amount of time. In the image forming apparatus 10, it is desirable to be able to efficiently form the plurality of test toner images having different developing voltage conditions on the surface of the intermediate transfer belt 441.

The plurality of processing modules of the CPU 80 include an adjustment portion 8d that executes the test output control and the development parameter adjustment process (see FIG. 3).

In the test output control, the adjustment portion 8d causes the printing device 4 to execute the test output process for forming the plurality of test toner images having different developing voltage conditions on the surface of the intermediate transfer belt 441. Each of the plurality of test toner images is a uniform solid image, a shaded image, an image with a uniform pattern, or the like.

The adjustment portion 8d executes the test output control and the development parameter adjustment process every time the adjustment condition is satisfied.

For example, the adjustment condition is a condition that the number of prints reaches a preset designated number. In addition, the adjustment condition may also be a condition that an accumulated value of the number of pixels drawn for each development color in the printing process reaches a preset designated number of pixels.

The CPU 80 including the adjustment portion 8d is an example of a processor that executes the test output control and the development parameter adjustment process. The control device 8, including the supply control portion 8b, the printing control portion 8c, and the adjustment portion 8d, is an example of a control portion that controls the image forming apparatus 10.

### [First Example of Test Output Control]

A procedure of a first example of the test output control will be described below with reference to the flowchart shown in FIG. 4.

In the following description, S101, S102, . . . represent identification symbols of a plurality of steps in the first example of the test output control. In the first example of the test output control, first, the process of step S101 is executed.

### <Step S101>

In step S101, the adjustment portion 8d selects two target photoconductors from among the four photoconductors 41.

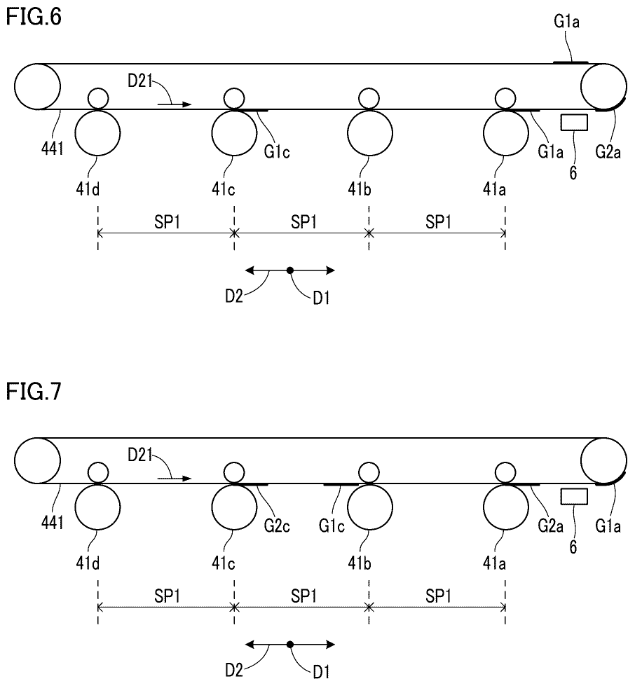

The two target photoconductors are two of the four photoconductors 41 that are arranged farther apart than an arrangement spacing SP1 of the four photoconductors 41 (see FIGS. 6 to 10). That is, the two target photoconductors are other than two adjacent photoconductors of the four photoconductors 41.

The four photoconductors 41 include a first photoconductor 41a, a second photoconductor 41b, a third photoconductor 41c, and a fourth photoconductor 41d, which are arranged in this order from the downstream side in the belt movement direction D21 (see FIGS. 6 to 10).

For example, the adjustment portion 8d selects the first photoconductor 41a and the third photoconductor 41c as the two target photoconductors for a first time. That is, in the first step S101, the adjustment portion 8d selects the two target image-carrying members that are arranged first and third among the four photoconductors 41 in the arrangement direction of the four photoconductors 41.

When the first photoconductor 41a and the third photoconductor 41c are selected as the two target photoconductors, spacing between the two target photoconductors is twice the arrangement spacing SP1.

After executing the process of step S101, the adjustment portion 8d executes the process of step S102.

### <Step S102>

In step S102, the adjustment portion 8d sets a number i that identifies a plurality of conditions of the developing voltage. In the present embodiment, the number i is selected from three numbers 1 to 3. In step S102 the first time, the number i is set to 1.

After executing the process of step S102, the adjustment portion 8d executes the process of step S103.

### <Step S103>

In step S103, the adjustment portion 8d sets the output voltage of the voltage output circuit 4b to an i-th developing voltage, which is one of a plurality of candidate voltages. Thus, the set developing voltage is applied to the four developing rollers 431.

After executing the process of step S103, the adjustment portion 8d executes the process of step S104.

### <Step S104>

In step S104, the adjustment portion 8d causes the image forming portion 4x to execute the i-th test output process. The i-th test output process in the first example is a process of forming an i-th test toner image on each of the surfaces of the two target photoconductors and transferring the i-th test toner image onto the surface of the intermediate transfer belt 441.

The i-th test toner image is one of the plurality of test toner images, and is formed under a condition in which the i-th developing voltage is applied to the four developing rollers 431.

After executing the process of step S104, the adjustment portion 8d executes the process of step S105.

### <Step S105>

In step S105, the adjustment portion 8d selects the next process depending on whether or not all of the plurality of test toner images for the two target photoconductors selected in step S101 have been output.

Here, it is assumed that the number of all the conditions of the developing voltage corresponding to the plurality of test toner images is N. In step S105, the adjustment portion 8d selects the next process depending on whether or not the Nth test output process has been executed.

In a case in which any of the N test toner images for the two target photoconductors has not yet been output, the adjustment portion 8d repeats the processes from step S102 onwards.

That is, the adjustment portion 8d counts up the number i in step S102 and then repeats the processes in steps S103 and S104 until all of the N test toner images for the two target photoconductors are output.

On the other hand, in a case in which all of the N test toner images for the two target photoconductors have been output, the adjustment portion 8d executes the process of step S106.

### <Step S106>

In step S106, the adjustment portion 8d selects the next process depending on whether or not all of the four photoconductors 41 have been selected as the two target photoconductors.

In the first example, in a case in which any of the four photoconductors 41 has not yet been selected as the two target photoconductors, the adjustment portion 8d repeats the processes from step S101 onwards.

In the first example, in the first step S101, the adjustment portion 8d selects the first photoconductor 41a and the third photoconductor 41c, which are arranged in the first and third positions among the four photoconductors 41, as the two target photoconductors.

Furthermore, in step S101 a second time, the adjustment portion 8d selects the second photoconductor 41b and the fourth photoconductor 41d, which are arranged second and fourth among the four photoconductors 41, as the two target photoconductors.

That is, in step S101, the adjustment portion 8d sequentially selects the two target photoconductors that are arranged first and third in the arrangement direction of the four photoconductors 41 out of the four photoconductors 41, and the remaining two target image-carrying members.

Even in a case in which the second photoconductor 41b and the fourth photoconductor 41d are selected as the two target photoconductors, the spacing between the two target photoconductors is twice the arrangement spacing SP1.

Each time two target photoconductors are selected, the adjustment portion 8d causes the image forming portion 4x to execute the test output processes from first to Nth so that the N test toner images for each of the two target photoconductors are transferred within an area on the surface of the intermediate transfer belt 441 whose length corresponds to the spacing between the two target photoconductors.

In the first example, each time two target photoconductors are selected, the adjustment portion 8d causes the image forming portion 4x to execute the test output process from the first to the Nth so that the N test toner images for each of the two target photoconductors are transferred within an area having a length equivalent to twice the arrangement spacing SP1 (see FIGS. 6 to 10).

In step S106, when all of the four photoconductors 41 have been selected as the two target photoconductors, the adjustment portion 8d ends the test output control.

FIGS. 6 to 10 show a process in which three test toner images are formed on each of the four photoconductors 41 by the first example of the test output control when N, which is the number of the developing voltage conditions, is three.

FIGS. 6 to 8 show a state in which the process of step S104 a first time to a third time is performed when the first photoconductor 41a and the third photoconductor 41c are selected as the two target photoconductors in step S101 the first time.

FIG. 6 shows a state in which a first test toner image G1a for the first photoconductor 41a and a first test toner image G1c for the third photoconductor 41c are simultaneously transferred onto the intermediate transfer belt 441 in step S104 the first time.

The first test toner images G1a and G1c are one of the three test toner images for the first photoconductor 41a and the third photoconductor 41c, and are toner images formed under a first developing voltage.

FIG. 7 shows a state in which a second test toner image G2a for the first photoconductor 41a and a second test toner image G2c for the third photoconductor 41c are simultaneously transferred onto the intermediate transfer belt 441 in step S104 the second time.

The second test toner images G2a and G2c are one of the three test toner images for the first photoconductor 41a and the third photoconductor 41c, and are toner images formed under a second developing voltage.

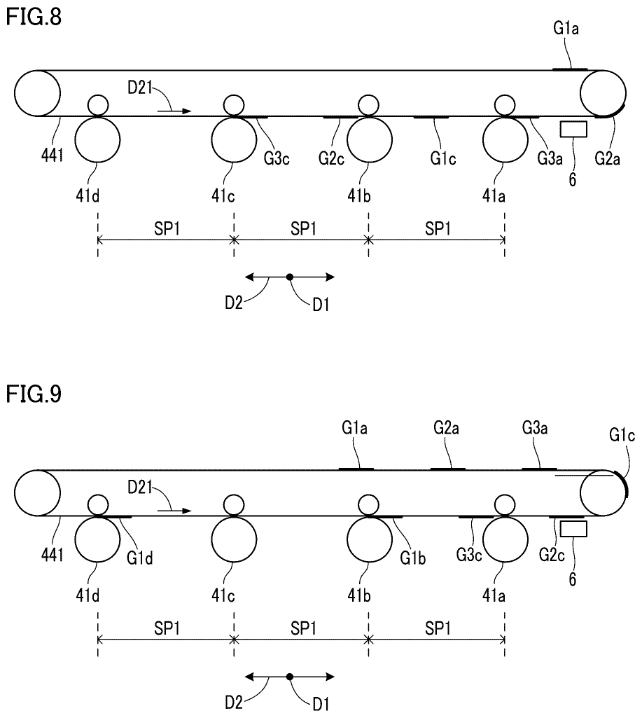

FIG. 8 shows a state in which a third test toner image G3a for the first photoconductor 41a and a third test toner image G3c for the third photoconductor 41c are simultaneously transferred onto the intermediate transfer belt 441 in step S104 the third time.

The third test toner images G1a and G1c are one of the three test toner images for the first photoconductor 41a and the third photoconductor 41c, and are toner images formed under a third developing voltage.

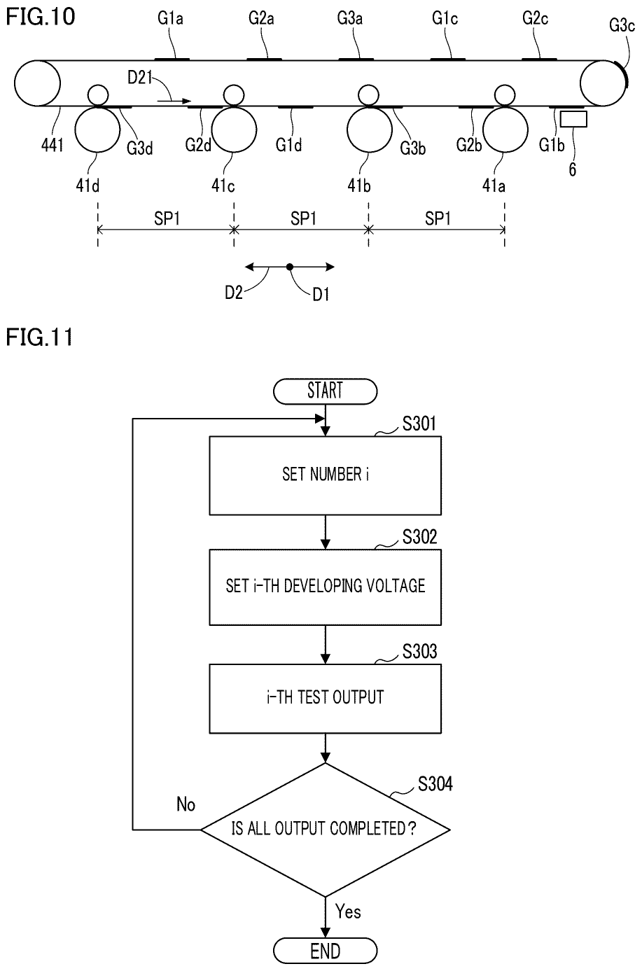

FIGS. 9 and 10 show a state in which the process of step S104 the first time to the third time is performed when the first photoconductor 41a and the third photoconductor 41c are selected as the two target photoconductors in step S101 the second time.

FIG. 9 shows a state in which a first test toner image G1b for the second photoconductor 41b and a first test toner image G1d for the fourth photoconductor 41d are simultaneously transferred onto the intermediate transfer belt 441 in step S104 the first time.

The first test toner images G1b and G1d are one of the three test toner images for the second photoconductor 41b and the fourth photoconductor 41d, and are toner images formed under the first developing voltage.

In FIG. 10, the second test toner images G2b and G2d are one of the three test toner images for the second photoconductor 41b and the fourth photoconductor 41d, and are toner images formed under the second developing voltage.

FIG. 10 shows a state in which a third test toner image G3b for the second photoconductor 41b and a third test toner image G3d for the fourth photoconductor 41d are simultaneously transferred onto the intermediate transfer belt 441 in step S104 the third time.

The third test toner images G3b and G3d are one of the three test toner images for the second photoconductor 41b and the fourth photoconductor 41d, and are toner images formed under the third developing voltage.

As shown in FIGS. 6 to 10, in a case in which the number of conditions for the development voltage is three, the adjustment portion 8d causes the image forming portion 4x to execute the first to third test output processes each time two target photoconductors are selected, so that three test toner images for each of the two target photoconductors are transferred within an area having a length equivalent to twice the arrangement spacing SP1.

By adopting the first example of the test output control, it is possible to efficiently form N test toner images while ensuring the length of the area on the surface of the intermediate transfer belt 441 in which the N test toner images are formed.

The first example of the test output control is particularly effective in a case in which the voltage output circuit 4b requires a relatively long time to change the developing voltage.

### [Development Parameter Adjustment Process]

Next, an example of the procedure for the development parameter adjustment process will be described with reference to the flowchart shown in FIG. 5.

The adjustment portion 8d executes the development parameter adjustment process in parallel with the test output control.

In the following description, S201, S202, . . . represent identification symbols of a plurality of steps in the development parameter adjustment process. In the development parameter adjustment process, first, the process of step S201 is executed.

### <Step S201>

In step S201, the adjustment portion 8d waits until the detection timing arrives, and executes the process of step S202 when the detection timing arrives.

The detection timing is the timing at which any one of the N test toner images for each of the four photoconductors 41 passes a position facing the density detecting portion 6. In the following description, one of the N test toner images for each of the four photoconductors 41 that passes the position facing the density detecting portion 6 is referred to as a target toner image.

### <Step S202>

In step S202, the adjustment portion 8d acquires information about the detected density of the target toner image from the density detecting portion 6, and stores the information about the detected density.

After executing the process of step S202, the adjustment portion 8d executes the process of step S203.

### <Step S203>

In step S203, the adjustment portion 8d selects the next process depending on whether or not the information about the detected densities of all of the N test toner images for each of the four photoconductors 41 has been acquired.

In a case in which acquisition of the detected density information of all of the N test toner images for each of the four photoconductors 41 has not been completed, the adjustment portion 8d repeats the processes of steps S201 to S203.

On the other hand, in a case in which the acquisition of the detected density information of all of the N test toner images for each of the four photoconductors 41 is completed, the adjustment portion 8d executes the process of step S204.

### <Step S204>

In step S204, the adjustment portion 8d adjusts the development parameters for each of the development colors in accordance with the detected densities of the N test toner images for each of the development colors.

For example, the development parameters include a correction value of the development voltage for each of the plurality of densities of an output image. In addition, the development parameters may also include a correction value for the exposure intensity by the exposure device 4a for each of the plurality of densities of the output image.

After executing the process of step S204, the adjustment portion 8d ends the development parameter adjustment process.

The development parameter adjustment process is an example of a process for adjusting the image forming portion 4x in accordance with the densities of the plurality of test toner images detected by the density detecting portion 6.

### [Second Example of Test Output Control]

Next, a procedure of a second example of the test output control will be described with reference to the flowchart shown in FIG. 11.

In the following description, S301, S302, . . . represent identification symbols of a plurality of steps in the second example of the test output control. In the second example of the test output control, first, the process of step S301 is executed.

### <Step S301>

In step S301, the adjustment portion 8d sets a number i that identifies a plurality of conditions of the developing voltage. The number i is selected from N numbers ranging from 1 to N. In step S301 a first time, the number i is set to 1.

After executing the process of step S301, the adjustment portion 8d executes the process of step S302.

### <Step S302>

In step S302, the adjustment portion 8d sets the output voltage of the voltage output circuit 4b to the i-th developing voltage, which is one of a plurality of candidate voltages. Thus, the set developing voltage is applied to the four developing rollers 431.

After executing the process of step S302, the adjustment portion 8d executes the process of step S303.

### <Step S303>

In step S303, the adjustment portion 8d causes the image forming portion 4x to execute the i-th test output process. The i-th test output process in the second example is a process of forming an i-th test toner image on the surface of each of the four photoconductors 41 and transferring the i-th test toner image onto the surface of the intermediate transfer belt 441.

The i-th test toner image is one of the plurality of test toner images, and is formed under a condition in which the i-th developing voltage is applied to the four developing rollers 431.

After executing the process of step S303, the adjustment portion 8d executes the process of step S304.

### <Step S304>

In step S304, the adjustment portion 8d selects the next process depending on whether or not all of the plurality of test toner images for the four photoconductors 41 have been output.

Here, it is assumed that the number of all the conditions of the developing voltage corresponding to the plurality of test toner images is N. In step S304, the adjustment portion 8d selects the next process depending on whether or not the Nth test output process has been executed.

In a case in which any one of the N test toner images for the four target photoconductors has not yet been output, the adjustment portion 8d repeats the processes from step S102 onwards.

That is, the adjustment portion 8d counts up the number i in step S301 and then repeats the processes in steps S302 and S303 until all of the N test toner images for the four target photoconductors are output.

On the other hand, in a case in which all of the N test toner images for the four photoconductors 41 have been output, the adjustment portion 8d ends the test image output control.

The adjustment portion 8d also executes the development parameter adjustment process shown in FIG. 5 in a case in which the second example of the test image output control is executed.

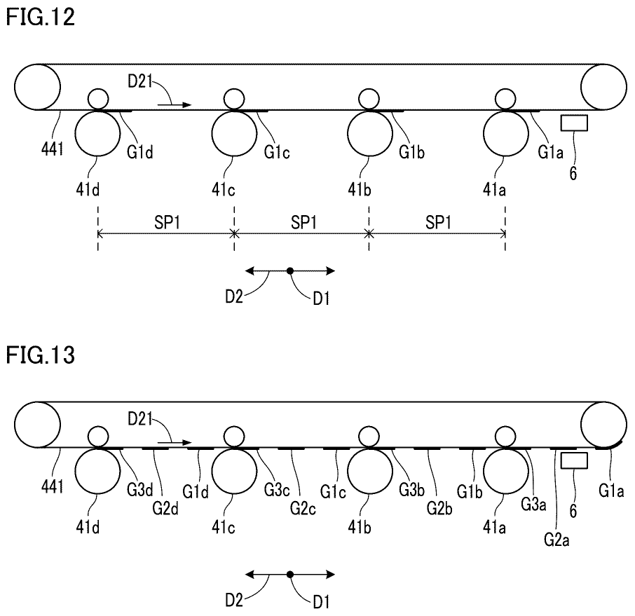

In the second example, the adjustment portion 8d causes the image forming portion 4x to execute test output processes from 1 to N so that the N test toner images for each of the four photoconductors 41 are transferred within an area of length corresponding to the arrangement spacing SP1 on the surface of the intermediate transfer belt 441 (see FIGS. 12 and 13).

FIGS. 12 and 13 show a process in which three test toner images are formed on each of the four photoconductors 41 by the second example of the test output control when N, which is the number of the developing voltage conditions, is three.

FIG. 12 shows a state in which the four first test toner images G1a, G1b, G1c, and G1d for the four photoconductors 41 are simultaneously transferred onto the intermediate transfer belt 441 in step S303 the first time.

FIG. 13 shows a state in which the four third test toner images G3a, G3b, G3c, and G3d for the four photoconductors 41 are simultaneously transferred onto the intermediate transfer belt 441 in step S303 the third time.

As shown in FIGS. 12 and 13, in a case in which the number of conditions for the developing voltage is three, the adjustment portion 8d causes the image forming portion 4x to execute the first to third test output processes so that three test toner images for each of the four photoconductors 41 are transferred within an area having a length corresponding to the arrangement spacing SP1.

By adopting the second example of the test output control, N test toner images can be efficiently formed on the surface of the intermediate transfer belt 441.

The second example of the test output control is effective when the time required for the voltage output circuit 4b to change the developing voltage is relatively short.

### Supplementary Notes of the Invention

In the following, an outline of the invention extracted from the above-described embodiments will be given. Note that the configurations and processing functions described in the following supplementary notes may be selected and combined as desired.

### Supplementary Note 1

An image forming apparatus, including:
an image forming portion including a plurality of image-carrying members arranged with spacing in between and a plurality of toner-carrying members arranged corresponding to the plurality of image-carrying members and to which a common developing voltage is applied, and configured to form a toner image of each of a plurality of development colors on a surface of each of the plurality of image-carrying members by toner supplied from each of the plurality of toner-carrying members;
a transfer device including an intermediate transfer body, which transfers the toner images on the surfaces of the plurality of image-carrying members to the intermediate transfer body, and configured to further transfer the toner images transferred to the intermediate transfer body to a sheet;
a density detecting portion configured to detect density of a toner image formed on a surface of the intermediate transfer body; and
a control portion configured to cause the image forming portion to execute a test output process in which a plurality of test toner images, each having a different developing voltage condition, are sequentially formed on the surface of each of the plurality of image-carrying members and transferred to the intermediate transfer body, and adjust the image forming portion in accordance with the densities of the plurality of test toner images detected by the density detecting portion; wherein
the control portion sequentially selects from the plurality of image-carrying members a plurality of target image-carrying members that are arranged at a distance greater than an arrangement spacing of the plurality of image-carrying members, and causes the image forming portion to execute the test output process so that each time one of the plurality of target image-carrying members is selected, the plurality of test toner images for each of the plurality of target image-carrying members are transferred within an area on the surface of the intermediate transfer body whose length corresponds to pacing between the plurality of target image-carrying members.

### Supplementary Note 2

The image forming apparatus according to Supplementary Note 1, wherein
the image forming portion includes four image-carrying members and four toner-carrying members corresponding to four development colors; and
the control portion sequentially selects two of the four image-carrying members that are positioned first and third in an arrangement direction of the four image-carrying members, and the remaining two target image carriers.

### Supplementary Note 3

An image forming apparatus, including:
an image forming portion including a plurality of image-carrying members arranged with spacing in between and a plurality of toner-carrying members arranged corresponding to the plurality of image-carrying members and to which a common developing voltage is applied, and configured to form a toner image of each of a plurality of development colors on a surface of each of the plurality of image-carrying members by toner supplied from each of the plurality of toner-carrying members;
a transfer device including an intermediate transfer body, which transfers the toner images on the surfaces of the plurality of image-carrying members to the intermediate transfer body, and configured to further transfer the toner images transferred to the intermediate transfer body to a sheet;
a density detecting portion configured to detect density of a toner image formed on a surface of the intermediate transfer body; and
a control portion configured to cause the image forming portion to execute a test output process in which a plurality of test toner images, each having a different developing voltage condition, are sequentially formed on the surface of each of the plurality of image-carrying members and transferred to the intermediate transfer body, and adjust the image forming portion in accordance with the densities of the plurality of test toner images detected by the density detecting portion; wherein
the control portion causes the image forming portion to execute the test output process so that the plurality of test toner images for each of the plurality of image-carrying members are transferred within an area having a length corresponding to the arrangement spacing of the plurality of image-carrying members on the surface of the intermediate transfer body.

### Supplementary Note 4

The image forming apparatus according to Supplementary Note 3, wherein
the image forming portion includes four image-carrying members and four toner-carrying members corresponding to four development colors.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an image forming portion including a plurality of image-carrying members arranged with spacing in between and a plurality of toner-carrying members arranged corresponding to the plurality of image-carrying members and to which a common developing voltage is applied, and configured to form a toner image of each of a plurality of development colors on a surface of each of the plurality of image-carrying members by toner supplied from each of the plurality of toner-carrying members;
a transfer device including an intermediate transfer body, which transfers the toner images on the surfaces of the plurality of image-carrying members to the intermediate transfer body, and configured to further transfer the toner images transferred to the intermediate transfer body to a sheet;
a density detecting portion configured to detect density of a toner image formed on a surface of the intermediate transfer body; and
a control portion configured to cause the image forming portion to execute a test output process in which a plurality of test toner images, each having a different developing voltage condition, are sequentially formed on the surface of each of the plurality of image-carrying members and transferred to the intermediate transfer body, and adjust the image forming portion in accordance with the densities of the plurality of test toner images detected by the density detecting portion; wherein
the control portion sequentially selects from the plurality of image-carrying members a plurality of target image-carrying members that are arranged at a distance greater than an arrangement spacing of the plurality of image-carrying members, and causes the image forming portion to execute the test output process so that each time one of the plurality of target image-carrying members is selected, the plurality of test toner images for each of the plurality of target image-carrying members are transferred within an area on the surface of the intermediate transfer body whose length corresponds to pacing between the plurality of target image-carrying members.

2. The image forming apparatus according to claim 1, wherein
the image forming portion includes four image-carrying members and four toner-carrying members corresponding to four development colors; and
the control portion sequentially selects two of the four image-carrying members that are positioned first and third in an arrangement direction of the four image-carrying members, and the remaining two target image carriers.

3. An image forming apparatus, comprising:
an image forming portion including a plurality of image-carrying members arranged with spacing in between and a plurality of toner-carrying members arranged corresponding to the plurality of image-carrying members and to which a common developing voltage is applied, and configured to form a toner image of each of a plurality of development colors on a surface of each of the plurality of image-carrying members by toner supplied from each of the plurality of toner-carrying members;
a transfer device including an intermediate transfer body, which transfers the toner images on the surfaces of the plurality of image-carrying members to the intermediate transfer body, and configured to further transfer the toner images transferred to the intermediate transfer body to a sheet;
a density detecting portion configured to detect density of a toner image formed on a surface of the intermediate transfer body; and
a control portion configured to cause the image forming portion to execute a test output process in which a plurality of test toner images, each having a different developing voltage condition, are sequentially formed on the surface of each of the plurality of image-carrying members and transferred to the intermediate transfer body, and adjust the image forming portion in accordance with the densities of the plurality of test toner images detected by the density detecting portion; wherein
the control portion causes the image forming portion to execute the test output process so that the plurality of test toner images for each of the plurality of image-carrying members are transferred within an area having a length corresponding to the arrangement spacing of the plurality of image-carrying members on the surface of the intermediate transfer body.

4. The image forming apparatus according to claim 3, wherein
the image forming portion includes four image-carrying members and four toner-carrying members corresponding to four development colors.
